(19) United States
(12) Patent Application Publication
(10) Pub. No.: US 2026/0211559 A1
(43) Pub. Date: Jul. 23, 2026

(54) Method and System for Data Buffering, Device, and Non-Volatile Readable Storage Medium

(71) Applicant: SUZHOU METABRAIN INTELLIGENT TECHNOLOGY CO., LTD., Suzhou, Jiangsu (CN)

(72) Inventors: Jiang WANG, Suzhou, Jiangsu (CN); Huajin SUN, Suzhou, Jiangsu (CN); Shuqing LI, Suzhou, Jiangsu (CN); Lin WANG, Suzhou, Jiangsu (CN); Xingyuan LI, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/140,760

(22) PCT Filed: Aug. 29, 2023
(86) PCT No.: PCT/CN2023/115582

§ 371 Date: Jun. 18, 2025

(30) Foreign Application Priority Data
Dec. 19, 2022 (CN) 202211634314.8

(51) Int. Cl. G06F 3/06

(52) U.S. Cl. CPC G06F 3/0619; G06F 3/0659; G06F 3/0689

(57) ABSTRACT

The present disclosure provides a method and system for data buffering, a device, and a non-volatile readable storage medium. The method includes: configuring an on chip buffer on a RAID management chip; reading new data from a host DDR into the on chip buffer, and obtaining new parity data by calculation according to a type of a current RAID group and the new data; and sending the new data to a data hard disk corresponding to a RAID group, and sending the new parity data to a parity hard disk corresponding to the RAID group.

### CROSS-REFERENCE TO RELATED APPLICATION

The present disclosure claims priority to Chinese Patent Application No. 202211634314.8, filed to the China National Intellectual Property Administration on Dec. 19, 2022 and entitled “Data Buffering Method and System, Device, and Storage Medium”, which is incorporated herein by reference in its entirety.

### TECHNICAL FIELD

The present disclosure relates to the field of hardware, and in particular, to a method and system for data buffering, a device, and a non-volatile readable storage medium.

### BACKGROUND

A RAID (Redundant Arrays of Independent Disks) group is generally composed of n data disks and m parity disks. According to different organization modes and algorithms, RAIDs can be classified into different RAID levels, and common RAIDs include RAID0 (n=k, m=0), RAID1 (n=1, m=1), RAID10 (n=k, m=k), RAID5 (n=k, m=1), RAID6 (n=k, m=2), etc., wherein k is a positive integer. In a process in which the RAID group responds to a write IO request of an upper computer, a hard RAID processing component first migrates data from a memory of the upper computer to a local storage space, and reads, according to a RAID level and the location of the hard RAID processing component in a RAID stripe, data on a corresponding hard disk to the local storage, then invokes a hard RAID calculation acceleration engine to calculate new parity data, and writes the new data and parity data into a disk. In this process, one write IO of the upper computer is amplified into multiple read/write IOs of a related hard disk by the RAID processing component, and this situation is called “write amplification”.

In the “write amplification” process, one potential performance bottleneck is the bandwidth of the local storage. Taking 4 KB modified write of RAID5 as an example, one write IO causes 9 times of read/write accesses to the local storage, which consumes 36 KB storage bandwidth. Generally, the local storage is achieved by an off-chip DDR (Double Data Rate, a double data rate synchronous dynamic random-access memory). Taking 128-bit dual-channel DDR4-3200 as an example, a theoretical bandwidth thereof is 51 GB/s, by estimation according to a DDR4 utilization of 60%, an actual bandwidth thereof is only about 30 GB/s, and thus it is obtained that the IOPS (Input/Output Operations Per Second, the number of IO operations per second) that can be provided for a 4 KB random write of the RAID5 of the upper computer is 833 K. Moreover, a data link between the RAID component and the upper computer is generally a PCIe link; and taking a PCIe Gen5×16 link as an example, a unidirectional link bandwidth thereof is 64 GB/s, and in the scenario of 4 KB random write of the RAID5, a link occupancy rate thereof is only about 5%. In addition, if a hard disk forming the RAID is an NVMe (NVM Express, a Non-Volatile Memory Host Controller Interface Specification) SSD (Solid State Drive), the IO performance release thereof is also greatly limited by the upper bandwidth limit of the off-chip DDR. To summarize, current hard RAID solutions facing NVMe SSDs are primarily limited by the upper bandwidth limit of traditional off-chip DDRs.

### SUMMARY

The present disclosure provides a method and system for data buffering, a computer device and a non-volatile readable storage medium.

According to a first aspect, provided is a method for data buffering, including the following steps: an on chip buffer is configured on a RAID management chip; new data is read from a host DDR into the on chip buffer, and new parity data is obtained by calculation according to a type of a current RAID group and the new data; and the new data is sent to a data hard disk corresponding to a RAID group, and the new parity data is sent to a parity hard disk corresponding to the RAID group.

In some embodiments, new parity data is obtained by calculation according to the type of the current RAID group and the new data, includes: in response to the RAID group being of a first type, a method for calculating the new parity data is determined according to a size of the new data; and in response to the RAID group being of a second type, the new parity data is obtained by calculation according to the new data, original data corresponding to the new data, first original parity data, and second original parity data.

In some embodiments, the method for calculating the new parity data is determined according to the size of the new data, includes: in response to the new data not exceeding a first threshold, the new parity data is obtained by calculation according to the new data, the original data corresponding to the new data and original parity data; and in response to the new data exceeding the first threshold, the new parity data is obtained by calculation according to the new data.

In some embodiments, the new parity data is obtained by calculation according to the new data, the original data corresponding to the new data and original parity data, includes: the original data corresponding to the new data is read from a first data hard disk to the on chip buffer, and the original parity data is read from a first parity hard disk to the on chip buffer.

In some embodiments, the method further includes: the new data is written into a first space of the on chip buffer, the original data corresponding to the new data is written into a second space of the on chip buffer, the original parity data is written into a third space of the on chip buffer, and the new parity data is written into a fourth space of the on chip buffer.

In some embodiments, the new data is sent to a data hard disk corresponding to the RAID group, and the new parity data is sent to the parity hard disk corresponding to the RAID group, includes: the new data is sent to the first data hard disk, and the new parity data is sent to the first parity hard disk.

In some embodiments, the method further includes: reading of the new data from the host DDR, reading of the original data corresponding to the new data from the first data hard disk and reading of the original parity data from the first parity hard disk are concurrently executed.

In some embodiments, the method further includes: writing of the new data into the first data hard disk and writing of the new parity data into the first parity hard disk are concurrently executed.

In some embodiments, the method further includes: the new data is written into the first space of the on chip buffer, and the new parity data is written into the fourth space of the on chip buffer.

In some embodiments, the new data is sent to the data hard disk corresponding to the RAID group, and the new parity data is sent to the parity hard disk corresponding to the RAID group, includes: the new data is evenly divided into multiple parts, each part is transmitted to each corresponding data hard disk, and the new parity data is transmitted to a corresponding parity hard disk.

In some embodiments, the method further includes: the transmission of each part of the new data to each corresponding data hard disk is concurrently executed.

In some embodiments, the new parity data is obtained by calculation according to the new data, original data corresponding to the new data, first original parity data, and second original parity data, includes: new first parity data and new second parity data are obtained by calculation according to the new data, the original data corresponding to the new data, the first original parity data and the second original parity data.

In some embodiments, the method further includes: the original data corresponding to the new data is read from a second data hard disk to the on chip buffer, the first original parity data is read from a second parity hard disk to the on chip buffer, and the second original parity data is read from a third parity hard disk to the on chip buffer.

In some embodiments, the method further includes: the new data is written into the first space of the on chip buffer, the original data corresponding to the new data is written into the second space of the on chip buffer, the first original parity data is written into the third space of the on chip buffer, the second original parity data is written into the fourth space of the on chip buffer, the new first parity data is written into a fifth space of the on chip buffer, and the new second parity data is written into a sixth space of the on chip buffer.

In some embodiments, the new data is sent to the data hard disk corresponding to the RAID group, and the new parity data is sent to the parity hard disk corresponding to the RAID group, includes: the new data is sent to the second data hard disk, the new first parity data is sent to the second parity hard disk, and the new second parity data is sent to the third parity hard disk.

In some embodiments, the method further includes: reading of the new data from the host DDR, reading of the original data corresponding to the new data from the second data hard disk, reading of the first original parity data from the second parity hard disk, and reading of the second original parity data from the third parity hard disk are concurrently executed.

In some embodiments, the method further includes: writing of the new data into the second data hard disk, writing of the new first parity data into the second parity hard disk, and writing of the new second parity data into the third parity hard disk are concurrently executed.

According to a second aspect, provided is a system for data buffering, including: a configuration component, configured to provide an on chip buffer on a RAID management chip; a calculation component, configured to read new data from a host DDR into the on chip buffer, and obtain new parity data by calculation according to a type of a current RAID group and the new data; and a sending component, configured to send the new data to a data hard disk corresponding to the RAID group, and send the new parity data to a parity hard disk corresponding to a RAID group.

According to a third aspect, further provided is a computer device, including: at least one processor; a memory, wherein the memory stores a computer instruction that can run on the processor, and the computer instruction, when executed by the processor, implements the steps of the method as described above.

According to a fourth aspect, further provided is a non-volatile readable storage medium, wherein the non-volatile readable storage medium stores a computer program, which when executed by a processor, implements the steps of the method as described above.

### BRIEF DESCRIPTION OF THE DRAWINGS

In order to describe the technical solutions in embodiments of the present disclosure or in the related art more clearly, hereinafter, accompanying drawings requiring to be used in the embodiments or the related art will be introduced briefly. Apparently, the accompanying drawings in the following description merely relate to some embodiments of the present disclosure, and for a person of ordinary skill in the art, other embodiments can also be derived from these accompanying drawings without involving any inventive effort.

FIG. 1 is a schematic diagram of an embodiment of a method for data buffering provided according to some embodiments of the present disclosure;

FIG. 2 is a schematic diagram of an embodiment of first-type data buffering provided according to some embodiments of the present disclosure;

FIG. 3 is a schematic diagram of another embodiment of first-type data buffering provided according to some embodiments of the present disclosure;

FIG. 4 is a schematic diagram of an embodiment of second-type data buffering provided according to some embodiments of the present disclosure;

FIG. 5 is a schematic diagram of an architecture for data buffering provided according to some embodiments of the present disclosure;

FIG. 6 is a schematic diagram of an embodiment of a system for data buffering provided according to some embodiments of the present disclosure;

FIG. 7 is a schematic diagram of a hardware structure of an embodiment of a computer device for data buffering provided according to some embodiments of the present disclosure; and

FIG. 8 is a schematic diagram of an embodiment of a non-volatile readable storage medium for data buffering provided according to some embodiments of the present disclosure.

### DETAILED DESCRIPTION OF THE EMBODIMENTS

In order to make objects, technical solutions and advantages of the present disclosure clearly understood, hereinafter, embodiments of the present disclosure will be described in detail in conjunction with embodiments and with reference to the accompanying drawings.

It should be noted that in the embodiments of the present disclosure, all expressions using “first” and “second” are used to distinguish two different entities or different parameters having the same name. Hence, “first” and “second” are only used for convenience of expression, should not be understood as limitations to embodiments of the present disclosure, and this will not be described one by one in subsequent embodiments.

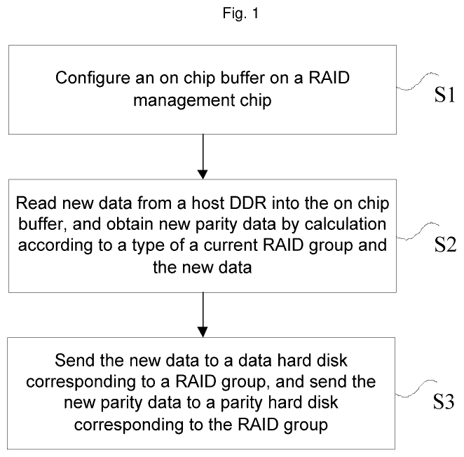

A first aspect of embodiments of the present disclosure provides an embodiment of a method for data buffering. FIG. 1 shows a schematic diagram of an embodiment of a method for data buffering provided according to some embodiments of the present disclosure. As shown in FIG. 1, the embodiment of the present disclosure includes the following steps:
S1: an on chip buffer is configured on a RAID (Redundant Arrays of Independent Disks) management chip;
S2: new data is read from a host DDR (Double Data Rate) into the on chip buffer, and new parity data is obtained by calculation according to the type of a current RAID group and the new data; and
S3: the new data is sent to a data hard disk corresponding to the RAID group, and the new parity data is sent to a parity hard disk corresponding to the RAID group.

The RAID technology is to organically combine a plurality of independent non-volatile storage media (SSD (Solid State Disk) or HDD (Hard Disk Drive, a mechanical hard disk)) into a whole, and the RAID presents as a storage device having data redundancy protection to an upper computer, and responds to a management and read/write IO (Input/Output) request of the upper computer. Taking RAID0 as an example, it converts one IO request of the upper computer into concurrent operations of a plurality of independent non-volatile readable storage medium, thereby improving the overall bandwidth and delay performance. The embodiments of the present disclosure are particularly directed to a RAID formed by NVMe (Non-Volatile Memory Express, a non-volatile memory-based transmission protocol) SSDs, and are based on a RAID acceleration scenario performed by hardware, in which an OCB (On Chip Buffer) is taken as a data buffer; thus, while a high storage bandwidth is provided, only a limited several MB (Mbyte, megabyte) level of buffer space is required, which can greatly improve the RAID write IO performance.

The on chip buffer is configured on the RAID management chip. New data is read from the host DDR into the on chip buffer, and new parity data is obtained by calculation according to the type of the current RAID group and the new data.

In some embodiments, new parity data is obtained by calculation according to the type of the current RAID group and the new data, includes: in response to the RAID group being of a first type, a method for calculating the new parity data is determined according to the size of the new data; and in response to the RAID group being of a second type, the new parity data is obtained by calculation according to the new data, original data corresponding to the new data, first original parity data, and second original parity data.

In some embodiments, the method for calculating the new parity data is determined according to the size of the new data, includes: in response to the new data not exceeding a first threshold, the new parity data is obtained by calculation according to the new data, original data corresponding to the new data and original parity data; and in response to the new data exceeding the first threshold, the new parity data is obtained by calculation according to the new data. For example, the first threshold can be 4 KB (Kilobyte), and if the new data does not exceed 4 KB, the new parity data is obtained by calculation according to the new data, the original data corresponding to the new data, and the original parity data; and if the new data exceeds 4 KB, the new parity data is obtained by calculation according to the new data.

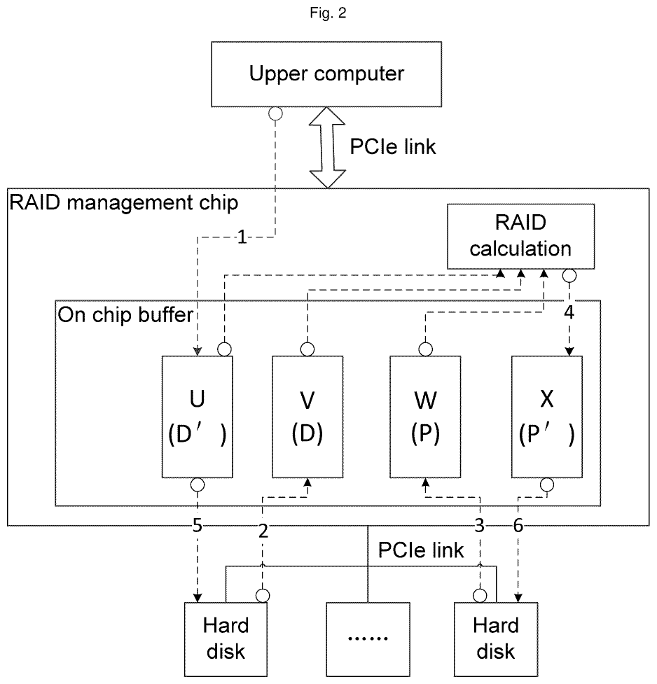

FIG. 2 is a schematic diagram of an embodiment of first-type data buffering provided according to some embodiments of the present disclosure. In some embodiments of the present disclosure, the first type is described using RAID5 as an example.

FIG. 2 shows one random write IO processing flow for 4 KB data of RAID5, wherein numerical sequence numbers on arrows represent a possible data operation sequence. D′ is new data of a host, D is corresponding original data to be overwritten on a hard disk, P is original parity data, P′ is newly calculated parity data, and the sizes thereof are all 4 KB. Different from conventional DDR-based data buffering, in some embodiments of the present disclosure, RAID processing-related data is buffered in a non-volatile readable storage medium of a RAID processing chip.

In some embodiments, the new parity data is obtained by calculation according to the new data, original data corresponding to the new data and original parity data, includes: original data corresponding to the new data is read from a first data hard disk to the on chip buffer, and the original parity data is read from a first parity hard disk to the on chip buffer.

In some embodiments, the method further includes: the new data is written into a first space of the on chip buffer, the original data corresponding to the new data is written into a second space of the on chip buffer, the original parity data is written into a third space of the on chip buffer, and the new parity data is written into a fourth space of the on chip buffer. That is, as shown in FIG. 2, new data D′ is read from the host DDR to an on chip buffer space U; original data D corresponding to the new data is read from a corresponding SSD to an on chip buffer space V; original parity data P is read from a corresponding SSD to an on chip buffer space W; and new parity data P′ is obtained by calculation according to D′, D and P, and is stored in an on chip buffer space X.

The new data is sent to a data hard disk corresponding to the RAID group, and the new parity data is sent to a parity hard disk corresponding to the RAID group.

In some embodiments, the new data is sent to a data hard disk corresponding to the RAID group, and the new parity data is sent to a parity hard disk corresponding to the RAID group, includes: the new data is sent to the first data hard disk, and the new parity data is sent to the first parity hard disk. That is, the new data D′ is written into a corresponding SSD, and the new parity data P′ is written into a corresponding SSD.

In some embodiments, the method further includes: reading of the new data from the host DDR, reading of the original data corresponding to the new data from the first data hard disk and reading of the original parity data from the first parity hard disk are concurrently executed.

In some embodiments, the method further includes: writing of the new data into the first data hard disk and writing of the new parity data into the first parity hard disk are concurrently executed.

For an NVMe SSD, it is set that a read IO delay of the NVMe SSD is a, a write IO delay of the NVMe SSD is b, and time consumed by RAID calculation processing is c, and then the duration of single IO processing can be approximately equal to 2a+2b+c. It is set that an IOPS design target value of small-IO (4 KB) random write of the system is M, then an on chip buffer size required is M×(2a+2b+c)×16 KB; and the on chip buffer bandwidth is: 9×M×4 KB. In order to shorten the processing delay of a single IO, the described steps are executed concurrently, then the delay of the single IO can be shortened to a+b+c, and the corresponding on chip buffer size required can be reduced to M×(a+b+c)×16 KB; and in the processing above, P′ can also be stored in the space W to overwrite the original parity data, and the corresponding on chip buffer space required is M×(2a+2b+c)×12 KB.

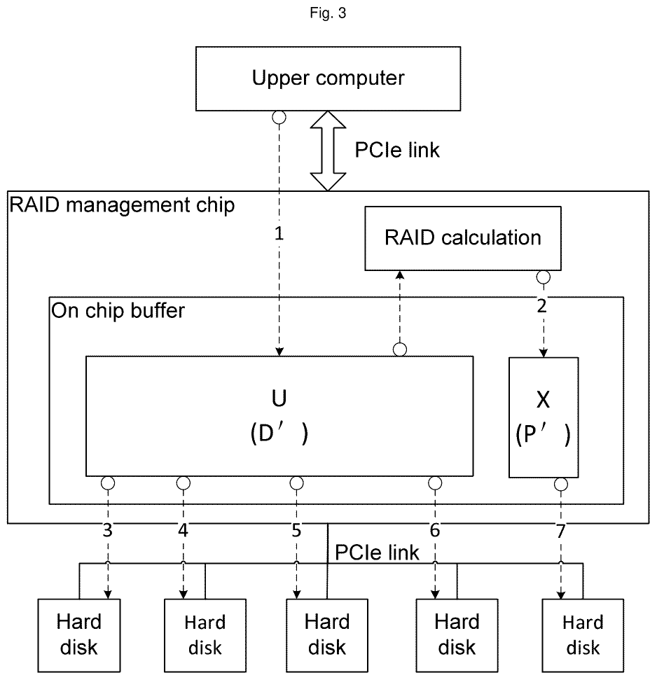

FIG. 3 is a schematic diagram of another embodiment of first-type data buffering provided according to some embodiments of the present disclosure. FIG. 3 shows one 256 KB write IO processing flow of RAID5 (5 hard disks forming the RAID5, the unit size of a stripe being 64 KB), and the RAID acceleration management chip performs aggregation and processing according to a full stripe. D′ is new data of 256 KB, and P′ is new parity data calculated by 64 KB. In some embodiments of the present disclosure, RAID processing-related data is buffered in a non-volatile readable storage medium of a RAID processing chip.

In some embodiments, the method further includes: the new data is written into a first space of the on chip buffer, and the new parity data is written into a fourth space of the on chip buffer. As shown in FIG. 3, new data D′ (256 KB) is read from the host DDR to an on chip buffer space U; and new parity data P′ is obtained by calculation according to D′, and is stored in an on chip buffer space X.

In some embodiments, the new data is sent to a data hard disk corresponding to the RAID group, and the new parity data is sent to a parity hard disk corresponding to the RAID group, includes: the new data is evenly divided into multiple parts, each part is transmitted to each corresponding data hard disk, and the new parity data is transmitted to a corresponding parity hard disk. As shown in FIG. 3, a first part of the new data D′ (64 KB) is written into a corresponding SSD; a second part of the new data D′ (64 KB) is written into a corresponding SSD; a third part of the new data D′ (64 KB) is written into a corresponding SSD; a fourth part of the new data D′ (64 KB) is written into a corresponding SSD; and new parity data P′ (64 KB) is written into a corresponding SSD.

In some embodiments, the method further includes: the transmission of each part of the new data to each corresponding data hard disk is concurrently executed.

More generally, with regard to RAID5/RAID6 formed by “n+m” disks (wherein n is the number of data disks, m is the number of parity disks, m=1 in a RAID5 scenario, and m=2 in a RAID6 scenario), an SSD write delay of an NVMe interface is set as b, time consumed by RAID calculation processing is c, and a design target bandwidth of sequential write set by the system is W.

Then the on chip buffer size required is:

$$\frac{W \times ( {( n + m )}^{2} \times b + ( n + m ) \times c )}{n} ;$$

and the on chip buffer bandwidth is:

$$\frac{W \times ( 3 n + 2 m )}{n} .$$

In order to shorten the processing delay of a single IO, the described steps are executed concurrently, then the delay of the single IO can be shortened to b+c.

The corresponding on chip buffer size required can be reduced to:

$$\frac{W \times ( n + m ) \times ( b + c )}{n} .$$

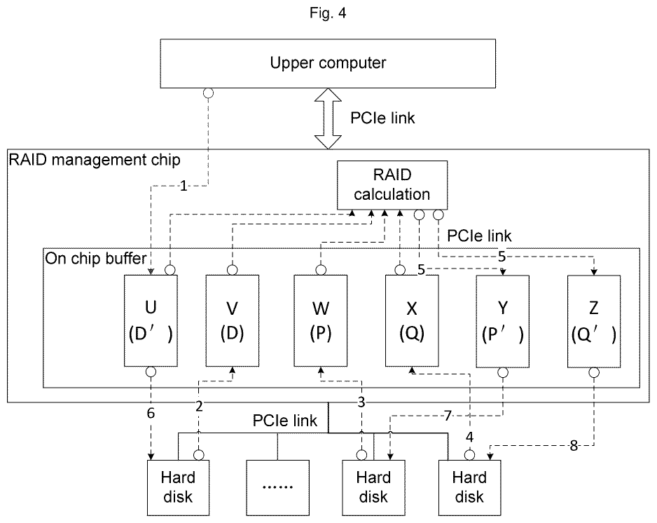

FIG. 4 is a schematic diagram of an embodiment of second-type data buffering provided according to some embodiments of the present disclosure. In some embodiments of the present disclosure, the second type is described using RAID6 as an example.

FIG. 4 shows one random write IO processing flow for 4 KB data of RAID6, wherein numerical sequence numbers on arrows represent a possible data operation sequence. D′ is newly written data of a host, D is corresponding original data to be overwritten on a hard disk, P/Q is first original parity data and second original parity data, P′/Q′ is newly calculated first parity data and second parity data, and the sizes thereof are all 4 KB. Different from conventional DDR-based data buffering, in some embodiments of the present disclosure, RAID processing-related data is buffered in a non-volatile readable storage medium of a RAID processing chip.

In some embodiments, the new parity data is obtained by calculation according to the new data, original data corresponding to the new data, first original parity data, and second original parity data, includes: new first parity data and new second parity data are obtained by calculation according to the new data, original data corresponding to the new data, first original parity data and second original parity data.

In some embodiments, the method further includes: the original data corresponding to the new data is read from a second data hard disk to the on chip buffer, the first original parity data is read from a second parity hard disk to the on chip buffer, and the second original parity data is read from a third parity hard disk to the on chip buffer.

In some embodiments, the method further includes: the new data is written into a first space of the on chip buffer, the original data corresponding to the new data is written into a second space of the on chip buffer, the first original parity data is written into a third space of the on chip buffer, the second original parity data is written into a fourth space of the on chip buffer, the new first parity data is written into a fifth space of the on chip buffer, and the new second parity data is written into a sixth space of the on chip buffer. As shown in FIG. 4, new data D′ is read from the host DDR to an on chip buffer space U; old data D is read from a corresponding SSD to an on chip buffer space V; old parity data P is read from a corresponding SSD to an on chip buffer space W; old parity data Q is read from a corresponding SSD to an on chip buffer space X; and new parity data P′ and Q′ are obtained by calculation according to D, P and Q, and stored in on chip buffer spaces Y and Z.

In some embodiments, the new data is sent to a data hard disk corresponding to the RAID group, and the new parity data is sent to a parity hard disk corresponding to the RAID group, includes: the new data is sent to the second data hard disk, the new first parity data is sent to the second parity hard disk, and the new second parity data is sent to the third parity hard disk. That is, the new data D′ is written into a corresponding SSD; and the new parity data P′ and Q′ are written into corresponding SSDs.

In some embodiments, the method further includes: reading of the new data from the host DDR, reading of the original data corresponding to the new data from the second data hard disk, reading of the first original parity data from the second parity hard disk, and reading of the second original parity data from the third parity hard disk are concurrently executed.

In some embodiments, the method further includes: writing of the new data into the second data hard disk, writing of the new first parity data into the second parity hard disk, and writing of the new second parity data into the third parity hard disk are concurrently executed.

For an NVMe SSD, it is set that a read IO delay of the NVMe SSD is a, a write IO delay of the NVMe SSD is b, and time consumed by RAID calculation processing is c, and then the duration of single IO processing can be approximately equal to 3a+3b+c. It is set that an IOPS design target value of small-IO (4 KB) random write of the system is M. Then the on chip buffer size required is: M×(3a+3b+c)×24 KB; and the on chip buffer bandwidth is: 13×M×4 KB.

In order to shorten the processing delay of a single IO, the described steps are executed concurrently, then the delay of the single IO can be shortened to a+b+c, and the corresponding on chip buffer size required can be reduced to M×(a+b+c)×24 KB. In the processing above, P′ and Q′ can also be stored in the spaces W and X to overwrite the original parity data, and the corresponding on chip buffer space required is M×(3a+3b+c)×16 KB.

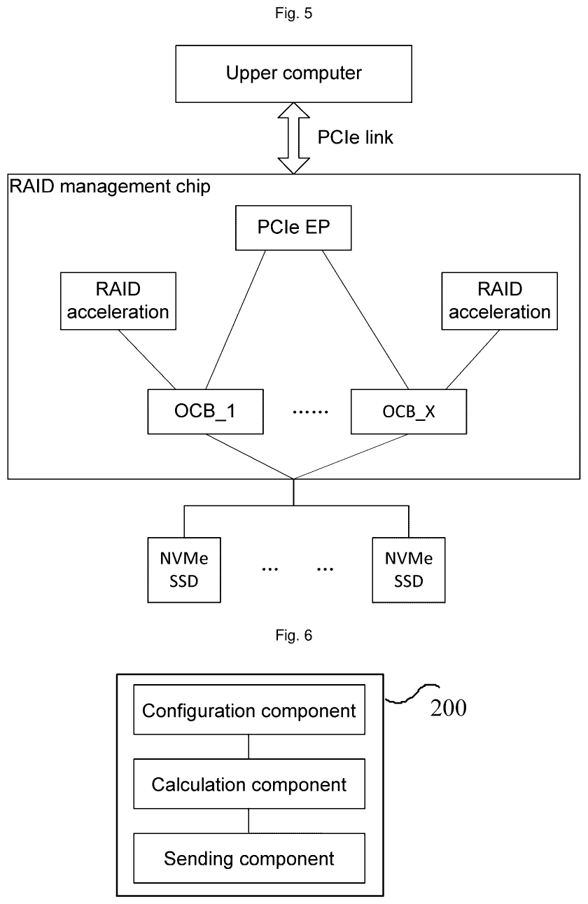

An interface of the NVMe SSD gradually supports PCIe Gen5, although the requirement for the on chip buffer space of the RAID chip is only on the order of several tens of MB, the requirement for the OCB bandwidth can require several hundreds of GB/s or more, which also brings challenge to engineering implementation. The present disclosure introduces a scheme of multiple OCBs, and achieves the overall performance by a plurality of parallel channels, and a schematic structural diagram thereof is as shown in FIG. 5, which consists of n OCBs, each OCB achieving 1/n capacity and bandwidth.

It should be particularly noted that, all steps in each embodiment of the method for data buffering as described above can be combined with each other, replaced, added, and deleted; therefore, with regard to the method for data buffering, these reasonable permutation, combination and transformation should also fall within the scope of protection of the present disclosure, and should not limit the scope of protection of the present disclosure to the embodiments.

On the basis of the object above, a second aspect of the embodiments of the present disclosure provides a system for data buffering. As shown in FIG. 6, the system 200 includes the following components: a configuration component, configured to provide an on chip buffer on a RAID management chip; a calculation component, configured to read new data from a host DDR into the on chip buffer, and obtain new parity data by calculation according to the type of a current RAID group and the new data; and a sending component, configured to send the new data is sent to a data hard disk corresponding to the RAID group, and send the new parity data to a parity hard disk corresponding to the RAID group.

In some embodiments, the calculation component is configured to in response to the RAID group being of a first type, determine a method for calculating the new parity data according to the size of the new data; and in response to the RAID group being of a second type, obtain the new parity data by calculation according to the new data, original data corresponding to the new data, first original parity data, and second original parity data.

In some embodiments, the calculation component is configured to in response to the new data not exceeding a first threshold, obtain the new parity data by calculation according to the new data, original data corresponding to the new data and original parity data; and in response to the new data exceeding the first threshold, obtain the new parity data by calculation according to the new data.

In some embodiments, the calculation component is configured to read original data corresponding to the new data from a first data hard disk to the on chip buffer, and read the original parity data read from a first parity hard disk to the on chip buffer.

In some embodiments, the system further includes: a writing component, configured to write the new data into a first space of the on chip buffer, write the original data corresponding to the new data into a second space of the on chip buffer, write the original parity data into a third space of the on chip buffer, and write the new parity data into a fourth space of the on chip buffer.

In some embodiments, the sending component is configured to send the new data to the first data hard disk, and send the new parity data to the first parity hard disk.

In some embodiments, the system further includes a first execution component, configured to: concurrently execute reading of the new data from the host DDR, reading of the original data corresponding to the new data from the first data hard disk and reading of the original parity data from the first parity hard disk.

In some embodiments, the system further includes a second execution component, configured to: concurrently execute writing of the new data into the first data hard disk and writing of the new parity data into the first parity hard disk.

In some embodiments, the system further includes a second writing component, configured to: write the new data into a first space of the on chip buffer, and write the new parity data into a fourth space of the on chip buffer.

In some embodiments, the sending component is configured to evenly divide the new data into multiple parts, transmit each part to each corresponding data hard disk, and transmit the new parity data to a corresponding parity hard disk.

In some embodiments, the system further includes a third execution component, configured to: concurrently execute the transmission of each part of the new data to each corresponding data hard disk.

In some embodiments, the calculation component is configured to: obtain new first parity data and new second parity data by calculation according to the new data, original data corresponding to the new data, first original parity data and second original parity data.

In some embodiments, the system further includes a reading component, configured to: read the original data corresponding to the new data from a second data hard disk to the on chip buffer, read the first original parity data from a second parity hard disk to the on chip buffer, and read the second original parity data from a third parity hard disk to the on chip buffer.

In some embodiments, the system further includes a third writing component, configured to: write the new data into a first space of the on chip buffer, write the original data corresponding to the new data into a second space of the on chip buffer, write the first original parity data into a third space of the on chip buffer, write the second original parity data into a fourth space of the on chip buffer, write the new first parity data into a fifth space of the on chip buffer, and write the new second parity data into a sixth space of the on chip buffer.

In some embodiments, the sending component is configured to send the new data to the second data hard disk, send the new first parity data to the second parity hard disk, and send the new second parity data to the third parity hard disk.

In some embodiments, the system further includes a fourth execution component, configured to: concurrently execute reading of the new data from the host DDR, reading of the original data corresponding to the new data from the second data hard disk, reading of the first original parity data from the second parity hard disk, and reading of the second original parity data from the third parity hard disk.

In some embodiments, the system further includes a fifth execution component, configured to: concurrently execute writing of the new data into the second data hard disk, writing of the new first parity data into the second parity hard disk, and writing of the new second parity data into the third parity hard disk.

On the basis of the object above, a third aspect of the embodiments of the present disclosure provides a computer device, including: at least one processor; and a memory, wherein the memory stores a computer instruction that can run on the processor, and the instruction, when executed by the processor, implements the following steps: S1: an on chip buffer is configured on a RAID management chip; S2: new data is read from a host DDR into the on chip buffer, and new parity data is obtained by calculation according to the type of a current RAID group and the new data; and S3: the new data is sent to a data hard disk corresponding to the RAID group, and the new parity data is sent to a parity hard disk corresponding to the RAID group.

In some embodiments, new parity data is obtained by calculation according to the type of the current RAID group and the new data, includes: in response to the RAID group being of a first type, a method for calculating the new parity data is determined according to the size of the new data; and in response to the RAID group being of a second type, the new parity data is obtained by calculation according to the new data, original data corresponding to the new data, first original parity data, and second original parity data.

In some embodiments, the method for calculating the new parity data is determined according to the size of the new data, includes: in response to the new data not exceeding a first threshold, the new parity data is obtained by calculation according to the new data, original data corresponding to the new data and original parity data; and in response to the new data exceeding the first threshold, the new parity data is obtained by calculation according to the new data.

In some embodiments, the new parity data is obtained by calculation according to the new data, original data corresponding to the new data and original parity data, includes: original data corresponding to the new data is read from a first data hard disk to the on chip buffer, and the original parity data is read from a first parity hard disk to the on chip buffer.

In some embodiments, the steps further include: the new data is written into a first space of the on chip buffer, the original data corresponding to the new data is written into a second space of the on chip buffer, the original parity data is written into a third space of the on chip buffer, and the new parity data is written into a fourth space of the on chip buffer.

In some embodiments, the new data is sent to a data hard disk corresponding to the RAID group, and the new parity data is sent to a parity hard disk corresponding to the RAID group, includes: the new data is sent to the first data hard disk, and the new parity data is sent to the first parity hard disk.

In some embodiments, the steps further include: reading of the new data from the host DDR, reading of the original data corresponding to the new data from the first data hard disk and reading of the original parity data from the first parity hard disk are concurrently executed.

In some embodiments, the steps further include: writing of the new data into the first data hard disk and writing of the new parity data into the first parity hard disk are concurrently executed.

In some embodiments, the steps further include: the new data is written into a first space of the on chip buffer, and the new parity data is written into a fourth space of the on chip buffer.

In some embodiments, the new data is sent to a data hard disk corresponding to the RAID group, and the new parity data is sent to a parity hard disk corresponding to the RAID group, includes: the new data is evenly divided into multiple parts, each part is transmitted to each corresponding data hard disk, and the new parity data is transmitted to a corresponding parity hard disk.

In some embodiments, the steps further include: the transmission of each part of the new data to each corresponding data hard disk is concurrently executed.

In some embodiments, the new parity data is obtained by calculation according to the new data, original data corresponding to the new data, first original parity data, and second original parity data, includes: new first parity data and new second parity data are obtained by calculation according to the new data, original data corresponding to the new data, first original parity data and second original parity data.

In some embodiments, the steps further include: the original data corresponding to the new data is read from a second data hard disk to the on chip buffer, the first original parity data is read from a second parity hard disk to the on chip buffer, and the second original parity data is read from a third parity hard disk to the on chip buffer.

In some embodiments, the steps further include: the new data is written into a first space of the on chip buffer, the original data corresponding to the new data is written into a second space of the on chip buffer, the first original parity data is written into a third space of the on chip buffer, the second original parity data is written into a fourth space of the on chip buffer, the new first parity data is written into a fifth space of the on chip buffer, and the new second parity data is written into a sixth space of the on chip buffer.

In some embodiments, the new data is sent to a data hard disk corresponding to the RAID group, and the new parity data is sent to a parity hard disk corresponding to the RAID group, includes: the new data is sent to the second data hard disk, the new first parity data is sent to the second parity hard disk, and the new second parity data is sent to the third parity hard disk.

In some embodiments, the steps further include: reading of the new data from the host DDR, reading of the original data corresponding to the new data from the second data hard disk, reading of the first original parity data from the second parity hard disk, and reading of the second original parity data from the third parity hard disk are concurrently executed.

In some embodiments, the steps further include: writing of the new data into the second data hard disk, writing of the new first parity data into the second parity hard disk, and writing of the new second parity data into the third parity hard disk are concurrently executed.

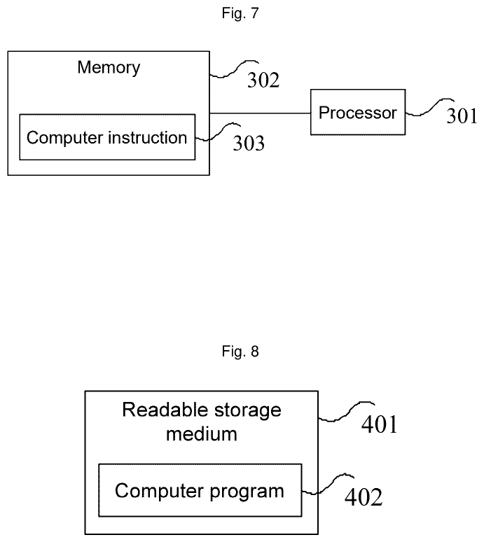

As shown in FIG. 7, it is a schematic diagram of a hardware structure of an embodiment of a computer device for data buffering provided according to some embodiments of the present disclosure.

Taking an apparatus as shown in FIG. 7 as an example, the apparatus includes a processor 301 and a memory 302.

The processor 301 and the memory 302 can be connected via a bus or in another manner, and connection via a bus is taken as an example in FIG. 7.

The memory 302, as a non-volatile readable storage medium, can be configured to store a non-volatile software program, a non-volatile computer-executable program and components, such as program instructions/components corresponding to the method for data buffering in the embodiments of the present disclosure. The processor 301 executes various functional applications and data processing of a server by running the non-volatile software program, instructions and components which are stored in the memory 302, that is, the method for data buffering is implemented.

The memory 302 can include a program storage area and a data storage area, wherein the program storage area can store an operating system and an application program required by at least one function; and the data storage area can store data created according to use of the method for data buffering, etc. In addition, the memory 302 can include a high-speed random access memory, and can further include a non-volatile memory, for example, at least one magnetic disk storage device, a flash memory device, or other non-volatile solid-state storage devices. In some embodiments, the memory 302 optionally includes a memory that is remotely arranged relative to the processor 301, and these remote memories can be connected to a local component via a network. Embodiment s of the network include, but are not limited to the Internet, an intranet, a local area network, a mobile communication network and combinations thereof.

One computer instruction 303 or more computer instructions 303 corresponding to methods for data buffering are stored in the memory 302, and when the computer instructions 303 are executed by the processor 301, the method for data buffering in any of the method embodiments as described above is executed.

Any embodiment of the computer device executing the method for data buffering as described above can achieve the same or similar effects as any method embodiments corresponding thereto.

The present disclosure further provides a non-volatile readable storage medium, wherein the non-volatile readable storage medium stores a computer program, which when executed by a processor, implements the method for data buffering.

As shown in FIG. 8, it is a schematic diagram of an embodiment of a non-volatile readable storage medium for data buffering provided according to some embodiments of the present disclosure. Taking the non-volatile readable storage medium shown in FIG. 8 as an example, the non-volatile readable storage medium 401 stores a computer program 402 for executing the described method when executed by a processor.

Finally, it should be noted that a person of ordinary skill in the art can understand that all or a part of the processes of the methods in the embodiments can be completed by a computer program instructing relevant hardware. The program for the method for data buffering can be stored in a non-volatile readable storage medium, and when the program is executed, the processes in the described various method embodiments can be included. The non-volatile readable storage medium of the program can be a magnetic disk, an optical disk, a read-only memory (ROM), or a random access memory (RAM), etc. The embodiments of the computer program can achieve the same or similar effects as any method embodiments corresponding thereto.

The content above merely relates to exemplary embodiments of the present disclosure, but it should be noted that various changes and modifications could be made without departing from the scope disclosed in the embodiments of the present disclosure as defined in the appended claims. The functions, steps and/or actions of the method claims in accordance with the disclosed embodiments described herein does not need to be executed in any particular sequence. In addition, although elements disclosed in the embodiments of the present disclosure can be described or claimed in an individual form, unless explicitly limited to a singular number, it is also understood that there can be multiple elements.

It should be understood that as used herein, the singular form “a (an)” is intended to include plural forms as well, unless the context clearly supports exceptions. It should also be understood that “and/or” as used herein refers to any and all possible combinations including one or more associated items listed.

The serial numbers of the embodiments disclosed in the embodiments of the present disclosure are only for illustration, and do not represent the preference of the embodiments.

A person of ordinary skill in the art would understand that all or some steps of the described embodiments can be completed by hardware, or be completed by a program instructing related hardware. The program can be stored in a non-volatile readable storage medium, and the non-volatile readable storage medium as mentioned above can be a read-only memory, a magnetic disk, an optical disk, or the like.

It should be understood by a person of ordinary skill in the art that the discussion of any embodiment above is merely exemplary, and is not intended to imply that the scope (including the claims) disclosed in embodiments of the present disclosure is limited to these embodiments. Under the idea of the embodiments of the present disclosure, technical features in the described embodiments or in different embodiments can also be combined, and there are many other variations of different aspects of the embodiments of the present disclosure, but for simplicity, they are not provided in detail. Therefore, any omissions, modifications, equivalent replacements, improvements, etc. made within the spirit and principle of embodiments of the present disclosure shall all fall within the scope of protection of the present disclosure.

1. A method for data buffering, comprising:
configuring an on chip buffer on a RAID management chip;
reading new data from a host DDR into the on chip buffer, and obtaining new parity data by calculation according to a type of a current RAID group and the new data; and
sending the new data to a data hard disk corresponding to a RAID group, and sending the new parity data to a parity hard disk corresponding to the RAID group.

2. The method according to claim 1, wherein obtaining the new parity data by calculation according to the type of the current RAID group and the new data, comprises:
in response to the RAID group being of a first type, determining, according to a size of the new data, a method for calculating the new parity data; and
in response to the RAID group being of a second type, obtaining the new parity data by calculation according to the new data, original data corresponding to the new data, first original parity data, and second original parity data.

3. The method according to claim 2, wherein determining, according to the size of the new data, the method for calculating the new parity data, comprises:
in response to the new data not exceeding a first threshold, obtaining the new parity data by calculation according to the new data, the original data corresponding to the new data and original parity data; and
in response to the new data exceeding the first threshold, obtaining the new parity data by calculation according to the new data.

4. The method according to claim 3, wherein obtaining the new parity data by calculation according to the new data, the original data corresponding to the new data and the original parity data, comprises:
reading the original data corresponding to the new data from a first data hard disk to the on chip buffer, and reading the original parity data from a first parity hard disk to the on chip buffer.

5. The method according to claim 4, wherein the method further comprises:
writing the new data into a first space of the on chip buffer, writing the original data corresponding to the new data into a second space of the on chip buffer, writing the original parity data into a third space of the on chip buffer, and writing the new parity data into a fourth space of the on chip buffer.

6. The method according to claim 5, wherein sending the new data to the data hard disk corresponding to the RAID group, and sending the new parity data to the parity hard disk corresponding to the RAID group, comprises:
sending the new data to the first data hard disk, and sending the new parity data to the first parity hard disk.

7. The method according to claim 6, wherein the method further comprises:
concurrently executing reading of the new data from the host DDR, reading of the original data corresponding to the new data from the first data hard disk and reading of the original parity data from the first parity hard disk.

8. The method according to claim 7, wherein the method further comprises:
concurrently executing writing of the new data into the first data hard disk and writing of the new parity data into the first parity hard disk.

9. The method according to claim 3, wherein the method further comprises:
writing the new data into the first space of the on chip buffer, and writing the new parity data into the fourth space of the on chip buffer.

10. The method according to claim 9, wherein sending the new data to the data hard disk corresponding to the RAID group, and sending the new parity data to the parity hard disk corresponding to the RAID group, comprises:
evenly dividing the new data into multiple parts, transmitting each part to each corresponding data hard disk, and transmitting the new parity data to a corresponding parity hard disk.

11. The method according to claim 10, wherein the method further comprises:
concurrently executing the transmission of each part of the new data to each corresponding data hard disk.

12. The method according to claim 2, wherein obtaining the new parity data by calculation according to the new data, original data corresponding to the new data, first original parity data, and second original parity data, comprises:
obtaining new first parity data and new second parity data by calculation according to the new data, the original data corresponding to the new data, the first original parity data and the second original parity data.

13. The method according to claim 12, wherein the method further comprises:
reading the original data corresponding to the new data from a second data hard disk to the on chip buffer, reading the first original parity data from a second parity hard disk to the on chip buffer, and reading the second original parity data from a third parity hard disk to the on chip buffer.

14. The method according to claim 13, wherein the method further comprises:
writing the new data into the first space of the on chip buffer, writing the original data corresponding to the new data into the second space of the on chip buffer, writing the first original parity data into the third space of the on chip buffer, writing the second original parity data into the fourth space of the on chip buffer, writing the new first parity data into a fifth space of the on chip buffer, and writing the new second parity data into a sixth space of the on chip buffer.

15. The method according to claim 14, wherein sending the new data to the data hard disk corresponding to the RAID group, and sending the new parity data to the parity hard disk corresponding to the RAID group, comprises:
sending the new data to the second data hard disk, sending the new first parity data to the second parity hard disk, and sending the new second parity data to the third parity hard disk.

16. The method according to claim 15, wherein the method further comprises:
concurrently executing reading of the new data from the host DDR, reading of the original data corresponding to the new data from the second data hard disk, reading of the first original parity data from the second parity hard disk, and reading of the second original parity data from the third parity hard disk.

17. The method according to claim 16, wherein the method further comprises:
concurrently executing writing of the new data into the second data hard disk, writing of the new first parity data into the second parity hard disk, and writing of the new second parity data into the third parity hard disk.

18. (canceled)

19. A computer device, comprising:
at least one processor; and
a memory, wherein the memory stores a computer instruction that can run on the processor, and the computer instruction, when executed by the processor, implements to:
configure an on chip buffer on a RAID management chip;
read new data from a host DDR into the on chip buffer, and obtain new parity data by calculation according to a type of a current RAID group and the new data; and
send the new data to a data hard disk corresponding to a RAID group, and send the new parity data to a parity hard disk corresponding to the RAID group.

20. A non-volatile readable storage medium, the non-volatile readable storage medium storing a computer program, wherein the computer program, when executed by a processor, implements to:
configure an on chip buffer on a RAID management chip;
read new data from a host DDR into the on chip buffer, and obtain new parity data by calculation according to a type of a current RAID group and the new data; and
send the new data to a data hard disk corresponding to a RAID group, and send the new parity data to a parity hard disk corresponding to the RAID group.

21. The method according to claim 1, further comprising:
buffering RAID processing-related data in a non-volatile readable storage medium of a RAID processing chip.
